(19) United States
(12) Patent Application Publication
(10) Pub. No.: US 2024/0119630 A1
(43) Pub. Date: Apr. 11, 2024

(54) SYSTEM AND METHOD OF OBSTACLE AND CLIFF DETECTION FOR A SEMI-AUTONOMOUS CLEANING DEVICE

(71) Applicant: Avidbots Corp, Kitchener (CA)

(72) Inventors: Weilong YE, Waterloo (CA); Adel FAKIH, Waterloo (CA); Bongkyun Jake PARK, Toronto (CA)

(21) Appl. No.: 18/481,002

(22) Filed: Oct. 4, 2023

Related U.S. Application Data
(60) Provisional application No. 63/413,580, filed on Oct. 5, 2022.

(51) Int. Cl. G06T 7/80; A47L 9/28; A47L 11/40

(52) U.S. Cl. CPC G06T 7/80; A47L 9/2805; A47L 9/2852; A47L 11/4002; A47L 11/4011; A47L 2201/04; G06T 2207/10028; G06T 2207/30261

(57) ABSTRACT

A system and method of obstacle and cliff detection for an autonomous or a semi-autonomous cleaning device utilizing a calibration health monitor and occupancy grid filters. A calibration health monitor is used for monitoring and making minor adjustments to camera calibration over time. An occupancy grid filter is a 3D occupancy grid for probabilistically observing obstacles with 3d sensors that are susceptible to noise or other inaccuracies.

### CROSS REFERENCE TO RELATED APPLICATIONS

The application claims priority to and the benefit of U.S. Provisional Patent Application Ser. No. 63/413,580, entitled “SYSTEM AND METHOD OF OBSTACLE AND CLIFF DETECTION FOR A SEMI-AUTONOMOUS CLEANING DEVICE” filed on Oct. 5, 2022, the disclosure of which is incorporated herein by reference in its entirety.

### BACKGROUND

The embodiments described herein relate to autonomous and semi-autonomous cleaning devices and more particularly, to a system and method for detecting the status of one or more components and/or systems in a semi-autonomous cleaning device to for improved cleaning of surfaces.

This disclosure relates to cleaning devices or robots that utilize Calibration Health Monitor (CHM) systems for monitoring and making minor adjustments to camera calibration over time. Cleaning devices or robots may use 3D sensors to detect obstacles and cliffs. The accuracy of 3D sensors' calibration is critical for the performance of obstacle and cliff detection.

All robots are statically calibrated before shipping to customers with acceptable calibration error, and a dynamic calibration is applied on the software level to address small calibration errors. The calibration error could increase due to the deformation of the sensor mount, loose mounting or other related problems. Once the error is out of the range of dynamic calibration, the robot will be running with large calibration errors and having more chances of hitting obstacles or stopping by a false obstacle/cliff.

Furthermore, an Occupancy Grid Filter (OGF) can also be used wherein a 3D occupancy grid for probabilistically observing obstacles with 3D sensors that are susceptible to noise or other inaccuracies is employed. An obstacle filtering is applied in the obstacle/cliff detection for noise reduction purposes. The current filtering algorithm is a combination of spatial filters in 3D space, which is very computationally expensive. The high CPU/processor load makes adding another high computational feature (e.g., cliff detection) very difficult.

There is a desire to provide an improved system and method for obstacle and cliff detection techniques. A calibration health monitor (CHM) would be very helpful to reduce the risk of collision, stopping and falling. A better filtering algorithm is required to reduce the CPU consumption to allow adding new features.

### SUMMARY

A system and method of obstacle and cliff detection for an autonomous or a semi-autonomous cleaning device utilizing a calibration health monitor and occupancy grid filters. A calibration health monitor is used for monitoring and making minor adjustments to camera calibration over time. An occupancy grid filter is a 3D occupancy grid for probabilistically observing obstacles with 3d sensors that are susceptible to noise or other inaccuracies.

### BRIEF DESCRIPTION OF THE DRAWINGS

FIG. 1 is a perspective view of a semi-autonomous cleaning device.

FIG. 2 is a front view of a semi-autonomous cleaning device.

FIG. 3 is a back view of a semi-autonomous cleaning device.

FIG. 4 is a left-side view of a semi-autonomous cleaning device.

FIG. 5 is a right-side view of a semi-autonomous cleaning device.

FIG. 6 is a table illustrating calibration parameters.

FIG. 7 is a table illustrating miscalibration levels.

FIG. 8 is a table illustrating effects of bad miscalibration.

FIG. 9 is a table illustrating the effect of miscalibration level in an exemplary embodiment.

FIG. 10 is a diagram illustrating an exemplary CHM pipeline.

FIG. 11 is a diagram illustrating an exemplary class hierarchy diagram.

FIG. 12 is a flow chart of an exemplary algorithm.

FIG. 13 is a diagram illustrating exemplary test results.

### DETAILED DESCRIPTION

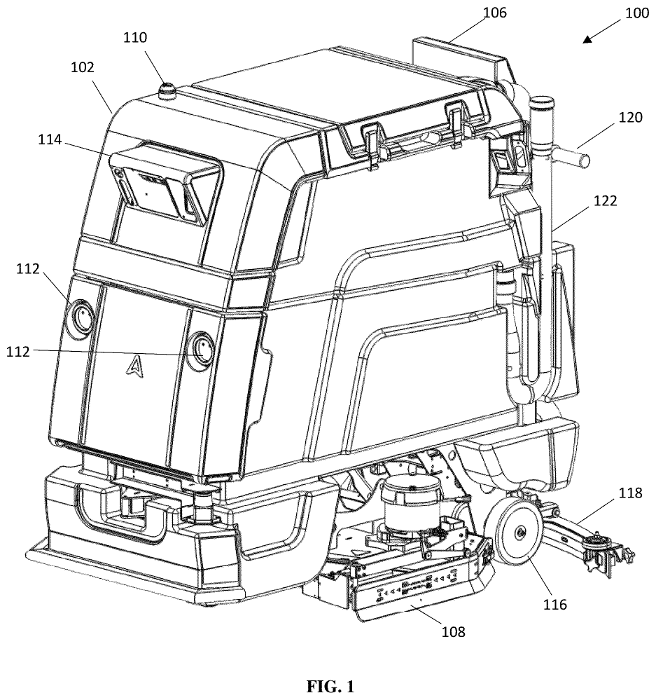

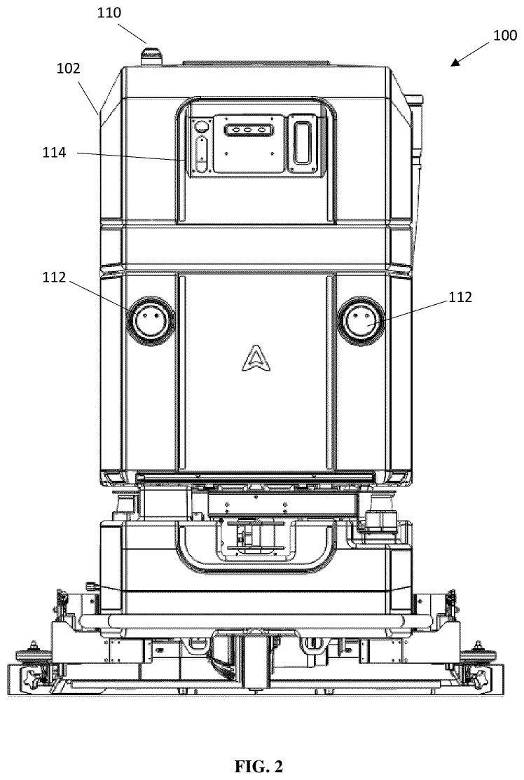

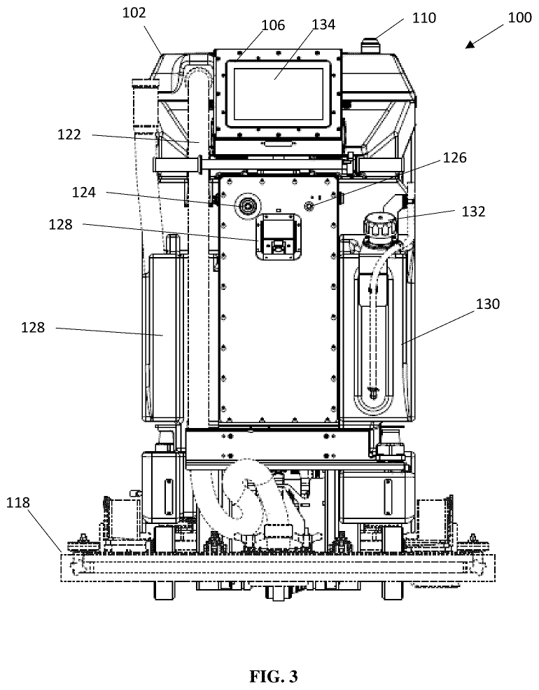

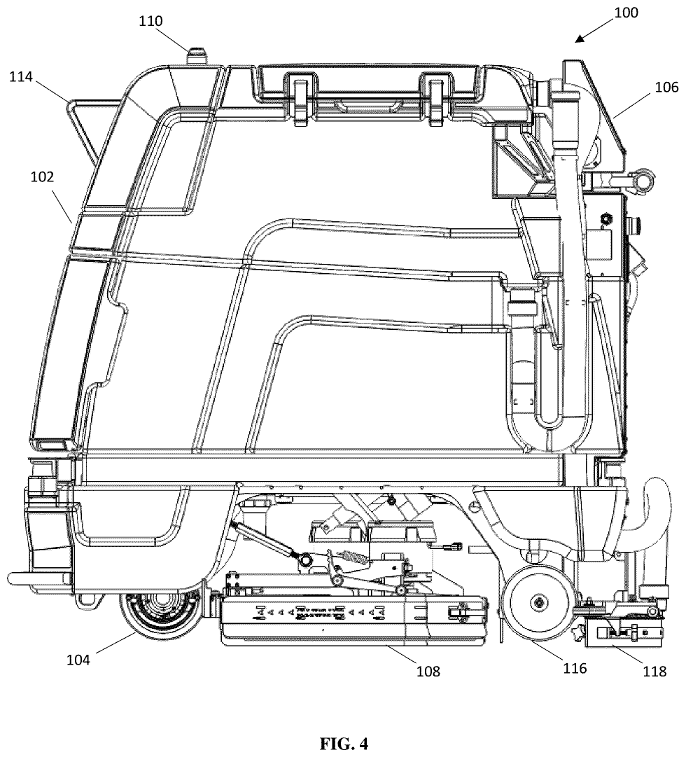

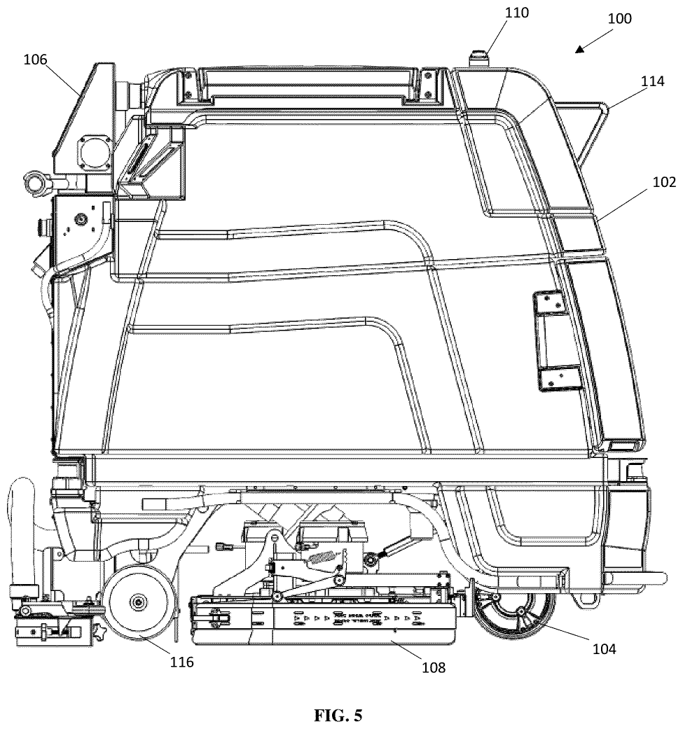

An exemplary embodiment of an autonomous or semi-autonomous cleaning device is shown in FIGS. 1-5. FIG. 1 is a perspective view of a semi-autonomous cleaning device. FIG. 2 is a front view of a semi-autonomous cleaning device. FIG. 3 is a back view of a semi-autonomous cleaning device. FIG. 4 is a left-side view of a semi-autonomous cleaning device, and FIG. 5 is a right-side view of a semi-autonomous cleaning device.

FIGS. 1 to 5 illustrate a semi-autonomous cleaning device 100. The device 100 (also referred to herein as “cleaning robot” or “robot”) includes at least a frame 102, a drive system 104, an electronics system 106, and a cleaning assembly 108. The cleaning robot 100 can be used to clean (e.g., vacuum, scrub, disinfect, etc.) any suitable surface area such as, for example, a floor of a home, commercial building, warehouse, etc. The robot 100 can be any suitable shape, size, or configuration and can include one or more systems, mechanisms, assemblies, or subassemblies that can perform any suitable function associated with, for example, traveling along a surface, mapping a surface, cleaning a surface, and/or the like.

The frame 102 of cleaning device 100 can be any suitable shape, size, and/or configuration. For example, in some embodiments, the frame 102 can include a set of components or the like, which are coupled to form a support structure configured to support the drive system 104, the cleaning assembly 108, and the electronic system 106. Cleaning assembly 108 may be connected directly to frame 102 or an alternate suitable support structure or sub-frame (not shown). The frame 102 of cleaning device 100 further comprises strobe light 110, front lights 112, a front sensing module 114 and a rear sensing module 128, rear wheels 116, rear skirt 118, handle 120 and cleaning hose 122. The frame 102 also includes one or more internal storage tanks or storing volumes for storing water, disinfecting solutions (i.e., bleach, soap, cleaning liquid, etc.), debris (dirt), and dirty water. More information on the cleaning device 100 is further disclosed in U.S. utility patent application Ser. No. 17/650,678, entitled “APPARATUS AND METHODS FOR SEMI-AUTONOMOUS CLEANING OF SURFACES” filed on Feb. 11, 2022, the disclosure which is incorporated herein by reference in its entirety.

More particularly, in this embodiment, the front sensing module 114 further includes structured light sensors in a vertical and horizontal mounting position, an active stereo sensor and a RGB camera. The rear sensing module 128, as seen in FIG. 3, consists of a rear optical camera. In further embodiments, front and rear sensing modules 114 and 128 may also include other sensors including one or more optical cameras, thermal cameras, LiDAR (Light Detection and Ranging), structured light sensors, active stereo sensors (for 3D) and RGB cameras.

The back view of a semi-autonomous cleaning device 100, as seen in FIG. 3, further shows frame 102, cleaning hose 122, clean water tank 130, clean water fill port 132, rear skirt 118, strobe light 110 and electronic system 106. Electronic system 106 further comprises display 134 which can be either a static display or touchscreen display. Rear skirt 118 consists of a squeegee head or rubber blade that engages the floor surface along which the cleaning device 100 travels and channels debris towards the cleaning assembly 108.

FIG. 3 further includes emergency stop button 124 which consists of a big red button, a device power switch button 126 and a rear sensing module 128. Rear sensing module 128 further comprises an optical camera that is positioned to sense the rear of device 100. This complements the front sensing module 114 which provides view and direction of the front of device 100, which work together to sense obstacles and obstructions.

### Calibration Parameters

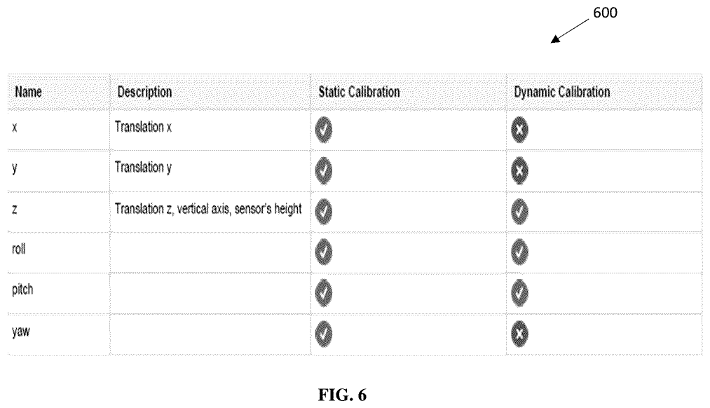

According to this disclosure, there are two calibration health monitor (CHM) calibration parameters. These parameters include static calibration and dynamic calibration. FIG. 6 is a table illustrating calibration parameters. According to table 600 of FIG. 6, a floor plane is detected for dynamic calibration. There is a limitation of calibrating x, y, yaw since the floor plane does not provide relative info to verify x, y, yaw. According to FIG. 6, data for z axis, roll, and path are considered as there may be miscalibration.

### Static Calibration

The static calibration is processed before using the 3D sensors of the robot. This so-called factory calibration can only happen once, and the parameters are saved permanently. The robot must be statically calibrated before all 3D sensors' data can be used for navigation. The static calibration is an individual process that is not included in the autonomous navigation loop; all parameters are calculated separately and set on an online command center portal. The robot syncs the value from the Avidbots Command Center fleet management website (ACC) for every reboot. Normally the static calibration results are fairly good with small errors (e.g., a few cm or a few degrees) at the beginning, but the errors could be increasing as the robot continues to operate.

### Dynamic Calibration

Dynamic calibration is part of the perception stack, to address small factory calibration errors by using the detected floor plane when the robot is on. Dynamic calibration values are only used for every power-on cycle of the robot software wherein dynamic calibration values are saved in memory, and will be reset for every reboot or service restart. The dynamic calibration can only be used for addressing small calibration errors, but by comparing the static calibration values and dynamic calibration values, bad miscalibration could be detected automatically and at an early stage.

Dynamic calibration is a module in the obstacle/cliff detection pipeline to address small miscalibration when the robot is running autonomously. It updates some of the calibration parameters while the obstacle/cliff detection pipeline is running by detecting the floor plane. The updated values are only used for the power-on cycle of the software, it won't modify the static calibration values on ACC.

### Miscalibration Level

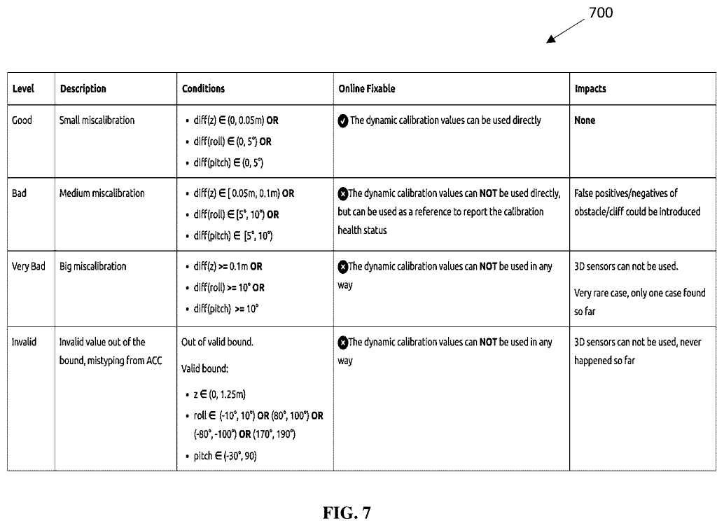

FIG. 7 is a table illustrating miscalibration levels. According to table 700 of FIG. 7, miscalibration can be separated to different levels by the size of the error. To determine the size of the error, the absolute difference between static calibration and dynamic calibration is calculated since the ground truth dynamically changes and is hard to get.

According to FIG. 7, Dynamic calibration values cannot be used when the values are too far from the static calibration values. They can only be used when the difference is small enough. Furthermore, the biggest plane that is detected and chosen for dynamic calibration could be a non-floor plane (wall, ramp, etc.).

### Effects of Bad Miscalibration

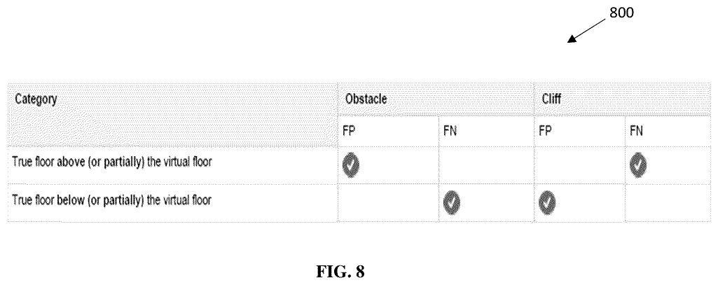

FIG. 8 is a table illustrating effects of bad miscalibration. According to table 800 of FIG. 8, the floor can be used as a key reference for describing the obstacle/cliff effects caused by bad miscalibration.

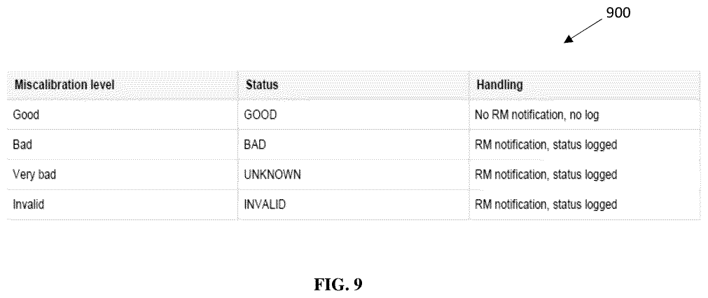

FIG. 9 is a table illustrating the effect of miscalibration level in an exemplary embodiment. According to FIG. 9, table 900 is based on comparing the static calibration values and dynamic calibration values, one can assess and monitor the calibration health and report to the remote monitoring (RM) message. Remote Monitoring is a web console within the Command Center portal. This enables the system to find the miscalibration issue and address them actively to prevent potential effects. One limitation is that the dynamic calibration cannot be used for all cases; however, useful information can still be collected to handle most of the cases.

According to FIG. 9, for the ‘UNKNOWN’ status, a very big difference is determined between static and dynamic calibration. One possibility is that the static calibration in this situation is actually very poor. The dynamic calibration is detecting the true floor as the reference. Another possibility is that the static calibration is good, but the dynamic calibration detects the wrong plane as the floor to be the reference. Given these two indistinguishable possibilities, the system cannot use dynamic calibration to assess the calibration health due to this limitation of dynamic calibration. These results are compiled as ‘UNKNOWN’.

### Static Calibration Validator

For the invalid status, a static calibration validator is introduced to report this status and prevent executing any downstream processing based on an ‘invalid’ situation. In this case, the whole obstacle/cliff pipeline won't be brought up successfully.

### Calibration Health Monitor

For “Good”, “Bad” and “Very bad” miscalibration levels, a calibration health monitor is introduced to report the status as described on above table, with limitation of reporting ‘very bad’.

### CHM Pipeline

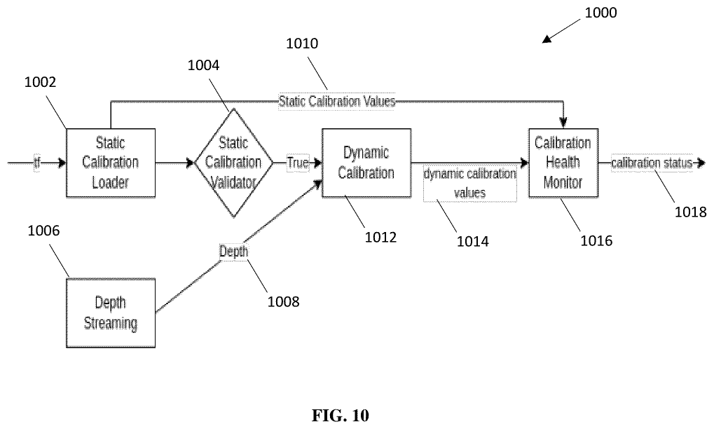

FIG. 10 is a diagram illustrating an exemplary CHM pipeline. According to FIG. 10, a logic illustration 1000 is shown of the CHM pipeline integrated into the obstacle/cliff pipeline. According to FIG. 10, the pipeline 1000 initiates with the data received at the Static Calibration Loader module 1002 which determines whether the values are true at the Static Calibration Validator module 1004. If so, data is sent to a Dynamic Calibration module 1012. Furthermore, a Depth Streaming module 1006 will also send depth value 1008 to the Dynamic Calibration module 1012.

According to FIG. 10, dynamic calibration values 1014 are generated from the Dynamic Calibration module 1012 and is sent to Calibration Health Monitor 1016. Further, static calibration values 1010 are also provided from the Static Calibration Loader 1002 to Calibration Health Monitor module 1016. Finally, the output of the Calibration Health Monitor 1016 is a calibration status 1018 provided to the semi-autonomous device.

### Occupancy Grid Filter (OGF)

The main reason for high CPU usage of 3D filtering is that all individual 3D points are being dealt with in 3D space. The main idea of occupancy grid filtering (OGF) is that the filtering decision can be made based on counting the number of points that are projected onto the same cell on the occupancy grid.

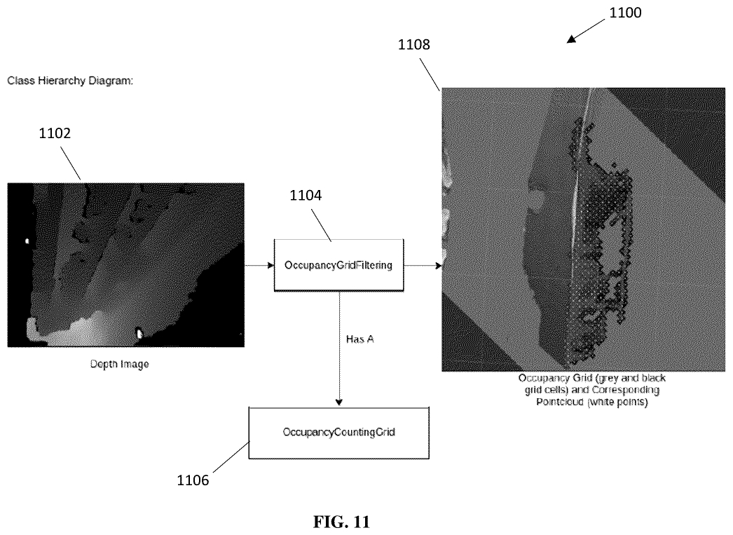

To address OGF, an occupancy counting grid algorithm is implemented. FIG. 11 is a diagram illustrating an exemplary class hierarchy diagram 1100. According to FIG. 11, a depth image 1102 is sent to an Occupancy Grid Filtering module 1104 which contains an instance of the Occupancy Counting Grid module 1106. The output of these modules is an Occupancy Grid image 1108.

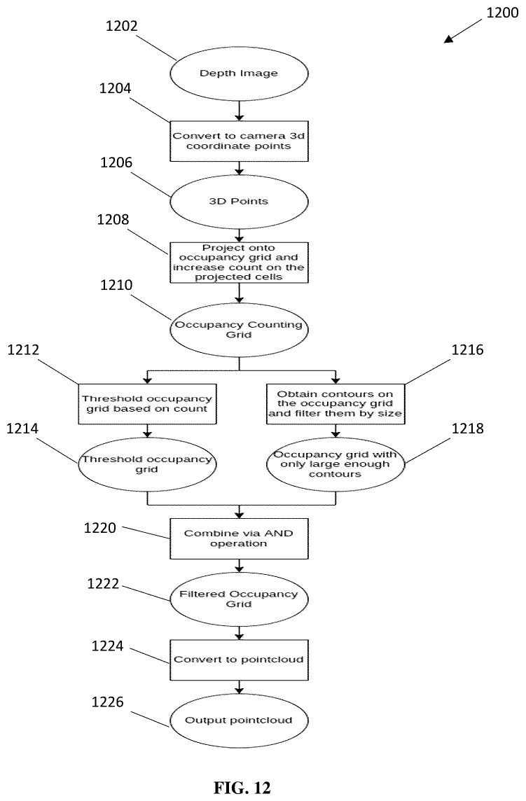

FIG. 12 is a flow chart of an exemplary algorithm. According to FIG. 12, flow chart 1200 initiates with Depth Image being acquired at step 1202. The camera converts the depth image to 3D coordinate points at step 1204. The 3D coordinate points at step 2106 are then projected onto the occupancy grid and increase the count on the projected cells at the Occupancy Grid at step 1210.

According to FIG. 12, the flow chart 1200 then forks into two paths; the left path relates to threshold occupancy grid based on count at step 1212 using a threshold occupancy grid module 1214 and the right path relates to occupancy grid with only large enough contours at step 1216 and step 1218. For the right path, contours are obtained on the occupancy grid and filter them by size at step 1216. Both paths are then combined via an AND operation at step 1220 at the Filtered Occupancy Grid 1222. Finally, the data is converted to a point cloud at step 1224 where it is then provided as an output at step 1226.

According to the disclosure, the implementation can be broken down into two parts:

occupancy_counting_grid.cpp
underlying grid like data structure for counting occupancy above the ground plane
the grid is parameterized by height, width and resolution
assumes that the camera origin exists at the bottom center of the grid
works with the following counting function
   count for the cell m is a function grid[m]=number of P(x,y,z) that is right above the grid cell
GetThresholdedOccupancyGrid( ) provides an occupancy grid that is thresholded by certain occupancy value—i.e. for all cell m in grid, grid[m]>threshold
   occupancy_grid_filter.cpp
algorithm class that filters occupancy data and outputs filtered data in pointcloud format—i.e. occupancy_grid_filter(depth image) filtered pointcloud data
ProcessPointCloud( ) is the main function that takes the depth image as input
algorithm uses FilterByContourSize( ) to filter out any small contours on the occupancy grid for any grid cell to be deemed occupied, the cell's count should be such that count>given threshold AND cell belongs to a counter larger than minimum size

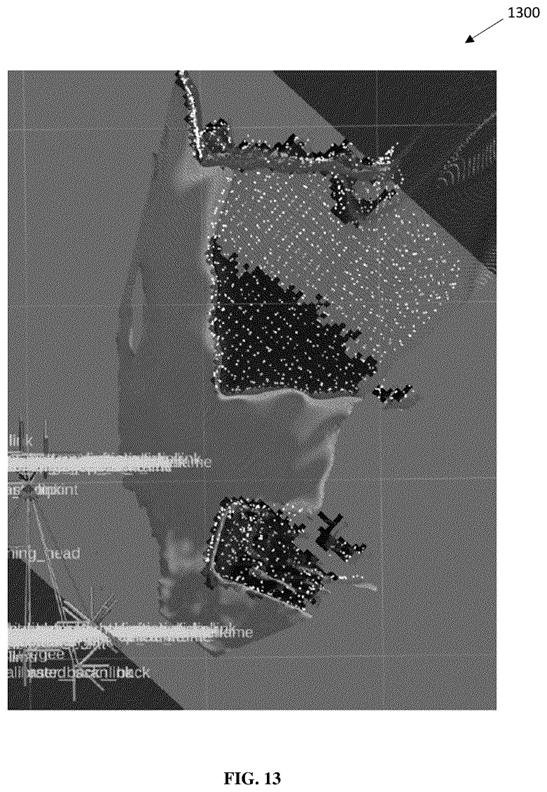

Parameters are managed by a floor estimation file under the device's description package. FIG. 13 is a diagram 1300 illustrating exemplary test results.

The solution in this disclosure comprises several differences to linked solutions, including:
The linked solution does not calibrate z position, and uses linear feature extraction extrapolated to a vanishing point. The solution disclosed here uses planar surfaces and does calibrate z-position, roll, and pitch.
The linked solution uses fiducial markers and is designed for multi-camera systems in which cameras are intentionally moved relative to one another. The solution disclosed here does not use fiducial markers and is designed for a single camera.
The linked solution uses multiple camera images. The solution disclosed here acts on a single image.

According to embodiments of this disclosure, a computer-implemented method for optimized 3D filtering for obstacle and cliff detection on a semi-autonomous cleaning device is provided. The cleaning device has a processor, a camera and one or more sensors. The method comprising the steps of acquiring a depth image with the camera and sensor, converting the depth image to 3D coordinate points, projecting the 3D coordinate points onto an occupancy grid, increasing the count on the projected cells of the occupancy grid, processing the threshold of the occupancy grid based on count, processing the occupancy grid based with large enough contours, combining the count occupancy grid and contour occupancy grid using a filtered occupancy grid, converting the filtered occupancy grid as a point cloud and providing an output of the point cloud of an occupancy grid image.

According to the disclosure, the sensor of the method is a 3D sensor. The step of processing the threshold of the occupancy grid based on count is done by the occupancy counting grid module. The step of processing the occupancy grid based with large enough contours is done by the occupancy grid filtering module.

According to the disclosure, the output of point cloud provided to a user or a remotely to central server. Furthermore, the method for optimized 3D filtering is configured to minimize high CPU usage.

According to the disclosure, a computer-implemented method using a calibration health monitor module for monitoring obstacle and cliff detection on a semi-autonomous cleaning device is disclosed. The method has a processor, a camera and one or more sensors. The method comprising the steps of receiving data at a static calibration loader module, the static calibration loader module configured to determine whether the values are true, if true, sending the data to the static calibration validator module, receiving depth data from a depth streaming module, receiving depth data from the depth streaming module and data from the static calibration validator module at a dynamic calibration module, the dynamic calibration module configured to generate dynamic calibration values, receiving at the calibration health monitor module, static calibration values from the static calibration loader module and dynamic calibration values from the dynamic calibration module and generating a calibration status at the calibration health monitor module. The step of providing an output of the calibration status is to the semi-autonomous cleaning device.

According to the disclosure, a system for obstacle and cliff detection for a semi-autonomous cleaning device is provided. The system comprises a processor, a camera, one or more 3D sensors, a calibration health monitor module and an occupancy grid filter configured to reduce CPU consumption. The calibration health monitor module is configured for monitoring and making minor adjustments to camera calibration over time. The occupancy grid filter is a 3D occupancy grid configured for probabilistically observing obstacles with the 3D sensors that are susceptible to noise or other inaccuracies.

According to disclosure, the occupancy grid filter of the system is optimized 3D filtering is configured to minimize high CPU usage. The system is further configured for processing the threshold of the occupancy grid based on count is done by the occupancy counting grid module.

According to the disclosure, the system is further configured for processing the occupancy grid based with large enough contours is done by the occupancy grid filtering module. The system is configured to provide an output of the point cloud of an occupancy grid image. Furthermore, the output of point cloud is provided to a user or a remotely to central server.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed:

1. A computer-implemented method for optimized 3D filtering for obstacle and cliff detection on a semi-autonomous cleaning device having a processor, a camera and one or more sensors, the method comprising the steps of:
acquiring a depth image with the camera and sensor;
converting the depth image to 3D coordinate points;
projecting the 3D coordinate points onto an occupancy grid;
increasing the count on the projected cells of the occupancy grid;
processing the threshold of the occupancy grid based on count;
processing the occupancy grid based with large enough contours;
combining the count occupancy grid and contour occupancy grid using a filtered occupancy grid;
converting the filtered occupancy grid as a point cloud; and
providing an output of the point cloud of an occupancy grid image.

2. The method of claim 1 wherein the sensor is a 3D sensor.

3. The method of claim 1 wherein the step of processing the threshold of the occupancy grid based on count is done by the occupancy counting grid module.

4. The method of claim 1 wherein the step of processing the occupancy grid based with large enough contours is done by the occupancy grid filtering module.

5. The method of claim 1 wherein the output of point cloud provided to a user or a remotely to central server.

6. The method of claim 1 wherein the method for optimized 3D filtering is configured to minimize high CPU usage.

7. A computer-implemented method using a calibration health monitor module for monitoring obstacle and cliff detection on a semi-autonomous cleaning device having a processor, a camera and one or more sensors, the method comprising the steps of:
receiving data at a static calibration loader module, the static calibration loader module configured to determine whether the values are true;
if true, sending the data to the static calibration validator module;
receiving depth data from a depth streaming module;
receiving depth data from the depth streaming module and data from the static calibration validator module at a dynamic calibration module, the dynamic calibration module configured to generate dynamic calibration values;
receiving at the calibration health monitor module, static calibration values from the static calibration loader module and dynamic calibration values from the dynamic calibration module; and
generating a calibration status at the calibration health monitor module.

8. The method of claim 1 further comprising the step of providing an output of the calibration status to the semi-autonomous cleaning device.

9. A system for obstacle and cliff detection for a semi-autonomous cleaning device, comprising:
a processor;
a camera;
one or more 3D sensors;
a calibration health monitor module; and
an occupancy grid filter configured to reduce CPU consumption;
wherein the calibration health monitor module is configured for monitoring and making minor adjustments to camera calibration over time;
wherein the occupancy grid filter is a 3D occupancy grid configured for probabilistically observing obstacles with the 3D sensors that are susceptible to noise or other inaccuracies.

10. The system of claim 9 wherein the occupancy grid filter is optimized 3D filtering is configured to minimize high CPU usage.

11. The system of claim 9 wherein the system is further configured for processing the threshold of the occupancy grid based on count is done by the occupancy counting grid module.

12. The system of claim 9 wherein the system is further configured for processing the occupancy grid based with large enough contours is done by the occupancy grid filtering module.

13. The system of claim 9 wherein the system is configured to provide an output of the point cloud of an occupancy grid image.

14. The system of claim 13 wherein the output of point cloud is provided to a user or a remotely to central server.
